(19) United States
(12) Patent Application Publication
(10) Pub. No.: US 2007/0241102 A1
(43) Pub. Date: Oct. 18, 2007

(54) Apparatus for microwave cooking of a food product

(75) Inventors: Gary Herbert Carmichael, Des Plaines, IL (US); Christopher Wright Dunkle, Buffalo Grove, IL (US); Craig T. Wilkie, Marietta, GA (US); David Allan Schroeder, Lombard, IL (US); James Belcastro, Park Ridge, IL (US)

Correspondence Address: FITCH EVEN TABIN & FLANNERY, 120 S. LASALLE STREET, SUITE 1600, CHICAGO, IL, 60603-3406, US

(73) Assignee: Kraft Foods Holdings, Inc.

(21) Appl. No.: 11/284,801

(22) Filed: Nov. 22, 2005

(51) Int. Cl. H05B 6/80

(52) U.S. Cl. 219/730

(57) ABSTRACT

A cooking apparatus for use in the microwave cooking of a food product is disclosed. The cooking apparatus includes a tray and a lid, both of which have susceptor surfaces in contact with the top and bottom surfaces of the food product, respectively. In addition, the tray elevates the food product from the bottom of a microwave, while the lid is unattached to the tray to permit the lid, and the susceptor surface thereon, to rise and/or fall according to any change in thickness of the food product during microwave cooking, thereby maintaining at least a portion of the susceptor surface of the lid in contact with the top surface of the food product.

### FIELD

The disclosure relates to an apparatus for microwave cooking of a food product, and in particular to an apparatus for microwave cooking of a food product including a first susceptor for contacting a top surface of the food product and a second susceptor for contacting a bottom surface of the food product.

### BACKGROUND

Heretofore, considerable effort has been expended to provide food products such as frozen or refrigerated pizzas and sandwiches for preparation by a consumer, utilizing conventional gas or electric heated ovens. More recently, with the increasing popularity of microwave ovens, attention has turned to providing consumers with kits and components for preparing dough-containing products such as frozen or refrigerated pizzas and sandwiches.

As has been detailed in U.S. Pat. No. 5,416,304, microwave ovens exhibit their own unique challenges when preparing frozen food products. For example, microwave ovens exhibit substantial temperature gradients or non-uniform heating. In addition, frozen dough-containing products have been found to exhibit a nonuniform temperature response to microwave radiation throughout their volume, during a typical heating cycle. As a result, portions of the food item melt or thaw before other portions and this results in localized accelerated heating due to the preferential absorption of microwave energy by liquids being irradiated. As a result of these and other conditions, further improvements in the preparation and packaging of dough-containing food products are being sought.

### SUMMARY

In one aspect, a cooking apparatus for use in the microwave cooking of a food product, such as a food product having dough-based portions, is disclosed. The cooking apparatus includes a tray and a lid, both of which have susceptor surfaces in contact with the top and bottom surfaces of the food product, respectively. In addition, the tray elevates the food product from the bottom of a microwave. The lid is unattached to the tray to permit the lid, and the susceptor surface thereon, to rise and/or fall according to any change in thickness of the food product during microwave cooking, thereby maintaining at least a portion of the susceptor surface of the lid in contact with the top surface of the food product.

In another aspect, the food product has at least an upper and lower portion. The cooking apparatus includes a base tray for supporting the food product. The base tray has a food product support surface with a susceptor thereon. The food product support surface has legs depending therefrom for elevating the food product support surface. The cooking apparatus also includes a cover lid. The cover lid has at least a pair of opposing side walls depending from a cover surface. A susceptor is disposed on the cover surface on a side facing the susceptor of the food product support surface. The cover lid is unattached to the base member, and the cover surface has substantially the same shape as the food product support surface. By having the cover lid and the base tray unattached to each other, the cover lid can move relative to the base tray in order to accommodate a change in the shape or size, and in particular the thickness, of the food product during microwave cooking. By being able to accommodate an increase or decrease in the size of the food product during microwave cooking, the cooking apparatus permits the susceptor of the base tray to be in contact with the lower portion of the food product and the susceptor of the cover lid to be in contact with the upper portion of the food product during microwave cooking.

In another aspect, a cooking apparatus is provided that has a first configuration for storage that is convertible to a second configuration for use in microwave cooking of a food product. The food product has an upper and lower portion. The cooking apparatus includes a base tray for supporting the food product. The base tray has a food product support surface with a susceptor on one side and legs for elevating the food product support surface. The cooking apparatus also includes a cover lid having at least a pair of opposing side walls depending from a cover surface. A susceptor is disposed on the cover surface on a side facing the susceptor of the food product support surface. The cooking apparatus also includes means for joining the base tray and the cover lid in the first configuration of the cooking apparatus. The means for joining the base tray and the cover lid permit separation of the base tray from the cover lid to convert the cooking apparatus from the first configuration for storage to the second configuration for use in microwave cooking of a food product.

In yet another aspect, a cooking apparatus in combination with a food product is disclosed. The cooking apparatus has a first configuration for storage and a second configuration for use in microwave cooking of the food product. The food product has a dough-based upper portion and a dough-based lower portion. A base tray and a lid are provided. The base tray supports the food product on a food product support surface thereof. The food product support surface has a susceptor on a side facing the lower portion of the food product. The food product support surface is elevated via depending legs. The cover lid has at least a pair of opposing sidewalls depending from a cover surface with a susceptor on a side facing the upper surface of the food product. The cover lid is unattached to the base tray in the second configuration of the cooking apparatus.

In accordance with any of the above aspects, the cooking apparatus may be packaged in an outer film wrapper with a food product contained therein. Means may be provided for joining the base tray and the cover lid in the first configuration of the cooking apparatus. The means for joining the base tray and the cover lid may permit separation of the base tray from the cover lid to convert the cooking apparatus from-the first configuration to the second configuration, and may comprise one of a tear strip, a thin die line, a perforated line, and a score line.

The cover surface of the cover lid may be generally polygonal, and in particular rectangular, and each side may have a depending side wall. The food product support surface of the base tray also may be generally polygonal, and in particular rectangular, and each side may have a depending leg. The base member may have a pair of upstanding extensions disposed on an opposite side of the food product support surface from the depending legs. The means for joining the base tray and the cover lid in the first configuration of the cooking apparatus may include joining the upstanding extensions to the adjacent depending legs.

The legs of the base member may each include one or more vents. The vents may be configured to permit for venting during microwave cooking. The vents may also be configured to permit for gas to escape, such as during gas-flushing of the base tray and cover lid when packaged in an outer wrapper. At least one of the vents may be an aperture formed in the leg. Alternatively, or in conjunction, at least one of the vents may be an arcuate cut-out.

The cover surface of the cover lid may be generally polygonal, and in particular rectangular, and each side may have a depending side wall. The food product support surface of the base tray may also be generally polygonal, and in particular rectangular, and each side may have a depending leg. The base member may have a pair of upstanding extensions disposed on an opposite side of the food product support surface from the depending legs. A distance between an upper extent of the extensions may be less than a distance between an opposing pair of the depending side walls, and in particular, a distance between the distal ends of the opposing pair of sidewalls, thus permitting the lid to at least partially fit over an upper portion of the extensions.

The susceptor surfaces may be formed separately from the lid and tray and attached thereto. Alternatively, the susceptor surfaces may be integrally formed with portions of the lid and tray. The susceptor surfaces may expand upon heating, thereby improving contact with at least some of non-planar portions of the upper and lower surfaces of the food product.

The base tray and cover lid of the cooking apparatus, with a food product therebetween, may be packaged within an outer film wrapper. In addition, an outer carton may be provided.

### BRIEF DESCRIPTION OF THE DRAWINGS

FIG. 1 is a perspective view of a first embodiment of a food cooking tray and lid with a sandwich therebetween within an outer wrapper and partially removed from an outer container;

FIG. 2 is a perspective view of the food cooking tray and lid with a sandwich therebetween of FIG. 1 partially removed from the outer wrapper;

FIG. 3 is a perspective view of the food cooking tray and lid with a sandwich therebetween of FIG. 1;

FIG. 3a is a section view of the food cooking tray and lid with a sandwich therebetween of FIG. 1 taken along line 3a-3a of FIG. 3 prior to heating

FIG. 3b is a section view of the food cooking tray and lid with a sandwich therebetween of FIG. 1 after heating;

FIG. 4 is a perspective view of a second embodiment of a food cooking tray and lid with a sandwich therebetween with a joining tear strip partially removed;

FIG. 5 is a perspective view of a third embodiment of a food cooking tray and lid with a sandwich therebetween with a joining tear strip partially removed;

FIG. 6 is a top plan view of an inner platform blank for use in forming the food cooking tray and lid of FIG. 5;

FIG. 7 is a top plan view of an outer blank for use in forming the food cooking tray and lid of FIG. 5;

FIG. 8 is a perspective view of a fourth embodiment of a food cooking tray and lid with a sandwich therebetween with a joining tear strip partially removed; and

FIG. 9 is a top plan view of an outer blank for use in forming the food cooking tray and lid of FIG. 8.

### DETAILED DESCRIPTION OF THE DRAWINGS

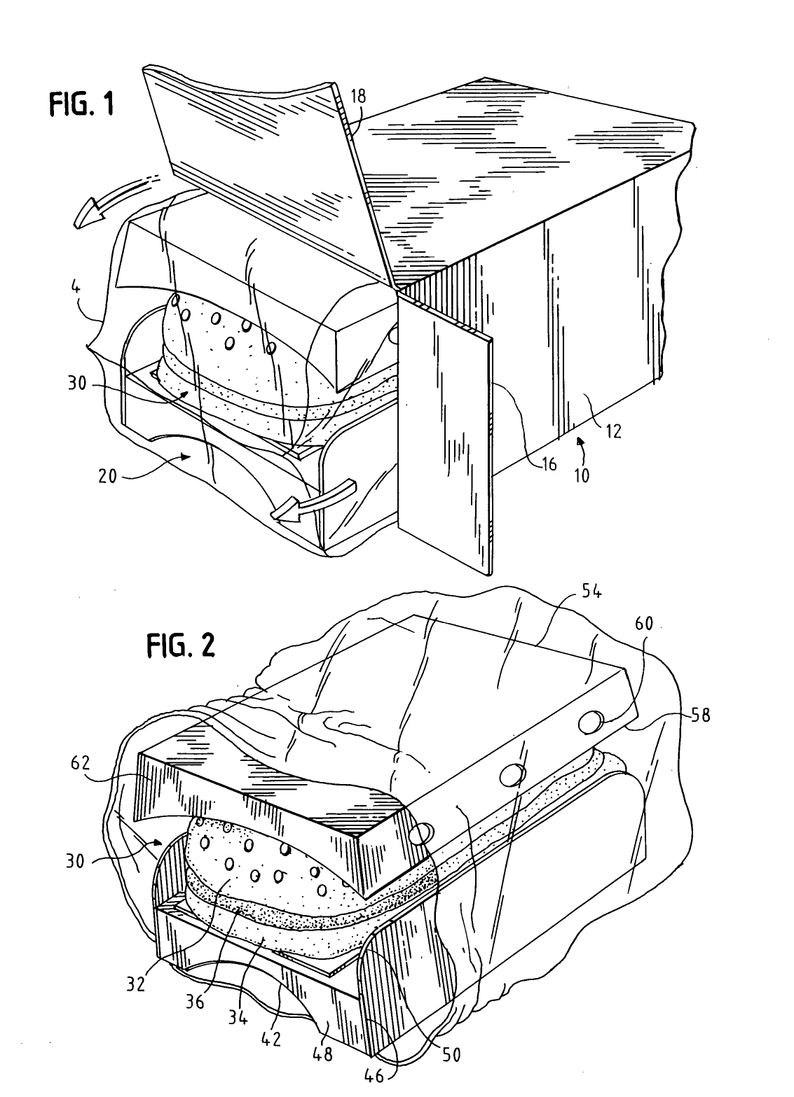

Various embodiments of a cooking apparatus in accordance with the above-discussed aspects are illustrated in FIGS. 1-9 herein. The cooking apparatus illustrated herein have base trays and lids. The base tray supports the food product at least partially on a susceptor, and the underside of the lid also has a susceptor for contacting the food product. The susceptors provide for conductive heating of the portions of the food product in contact herewith. The base tray and lid are separate from each other during microwave cooking in order to permit the lid, and the susceptor material thereon, to maintain contact with the food product, such as when the thickness of the food product changes during a cooking cycle. Legs are provided to elevate the susceptor of the base tray, and thus the food product, above the floor of a microwave during the cooking cycle to promote more even microwave cooking, particularly of the bottom of the food product, as will be explained in greater detail herein. In addition, the lid may include depending sidewalls to assist in maintaining the lid, and thus the susceptor on the underside thereof, in position on the food product during microwave heating.

In microwave cooking, polar molecules such as water contained in the food product absorb microwave energy and release heat. Microwave energy typically penetrates further into the food than does heat generated in a conventional oven, such as radiant heat, with the result that water molecules dispersed throughout the food product are selectively heated more rapidly. Ideally, food products such as those in dough-based portions of sandwiches, pockets and other such food products must properly dissipate the heated moisture in order to avoid the dough-based portion becoming soggy.

The food product being prepared may be supported at an elevated position above the oven surface to allow a desirable portion of the moisture exiting the food product, such as if vents holes are present in the food product support surface, to become trapped in a determined volume so as to contribute controlled amounts of heat and moisture to the dough-based portion of the food product and to achieve a desirable brownness or crispness without becoming dried out, chewy or hard. The food product is supported at an elevated position above the oven surface to allow cooking energy, such as microwaves to be deflected underneath the food product, to reach the bottom portion of the food product and achieve sufficient penetration of the food product. Thus, it can be preferable to achieve a proper ratio of moisture exiting the food product being prepared between a trapped portion used for heating of the food product and a released portion which is allowed to escape the food product to prevent its becoming soggy or chewy or otherwise undesirably moist.

Other problems associated with the use of microwave energy for the preparation of food products such as frozen or refrigerated sandwich, pockets and the like are also addressed. In general, certain instances of non-uniform heating can be associated with the preparation of food using microwave energy, such as electromagnetic radiation at a frequency of about 0.3 to 300 GHz. It can be important in order to achieve a cooked food product of pleasing appearance and texture that the dough-based portion of the food product be uniformly heated throughout the cooking. As is now generally accepted, power distribution in a microwave oven cavity can be non-uniform, giving rise to “hot spots” and “cold spots” about the environment of the food product being prepared.

Another problem in many practical applications arises from the fact that a food product such as a frozen sandwich typically does not exhibit desirably uniform temperature response to microwave radiation throughout its volume, during a typical heating cycle. For example, a frozen sandwich when initially subjected to microwave radiation, undergoes local melting or thawing in certain portions of the sandwich, with remaining portions of the sandwich remaining frozen. This problem is accelerated in that thawed portions of a dough-based food product, such as a sandwich, pocket or the like, will preferentially absorb greater amounts of microwave energy than the surrounding frozen portions. A further understanding of difficulties encountered in preparing dough-containing food products such as frozen pizza may be found in U.S. Pat. No. 5,416,304, the disclosure of which is herein incorporated by reference as fully set forth herein. It is important therefore that initial thawing of the food product be made as uniform as possible throughout the food product and that the energy absorption throughout the remainder of the cooking cycle remain uniform. A number of different features of the cooking apparatus disclosed herein provide improved control of microwave cooking of dough-containing food products, throughout the cooking cycle.

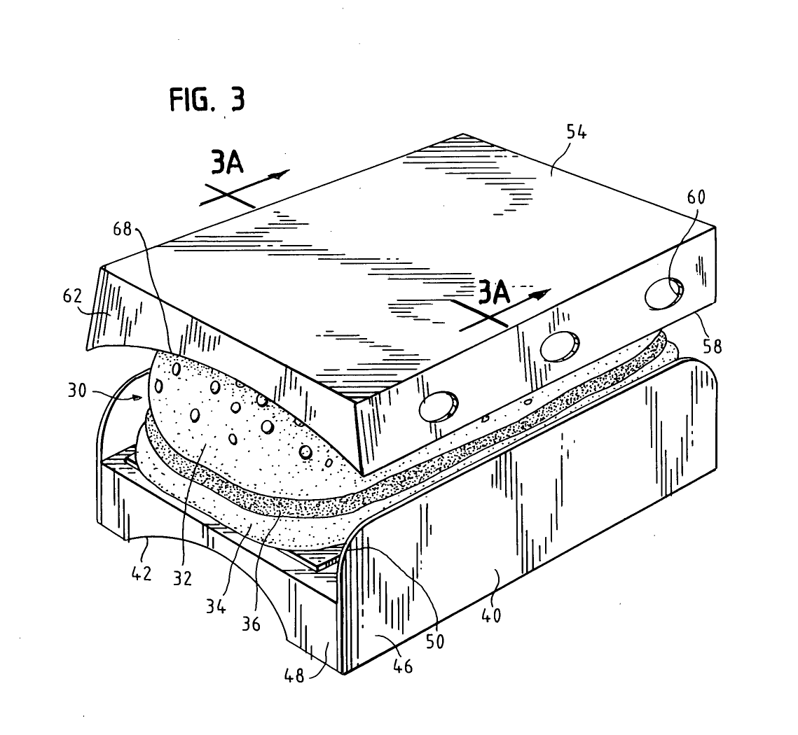

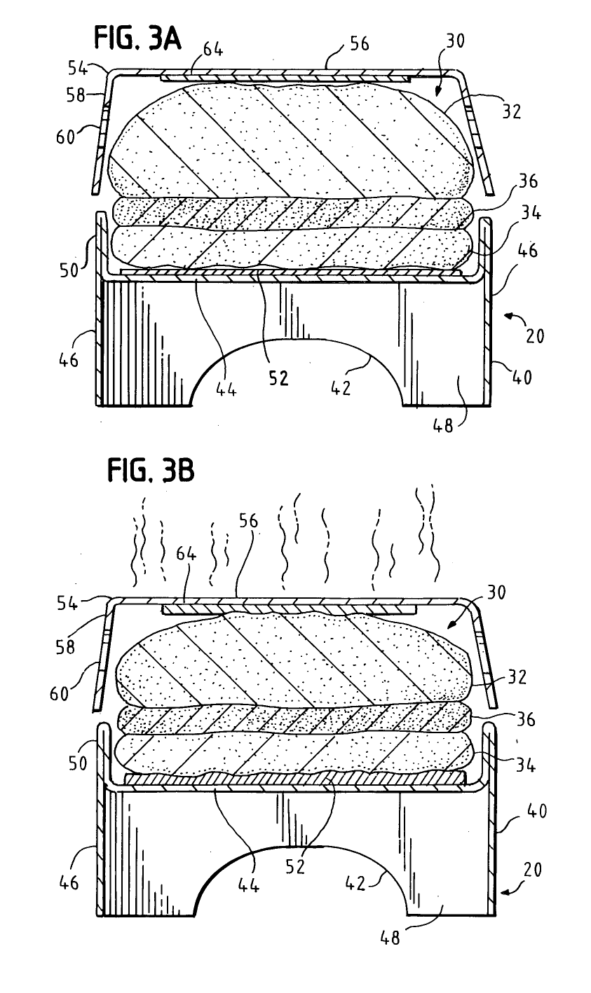

In one illustrated embodiment of FIGS. 1-3, the cooking apparatus 10 comprises a separate tray 40 and lid 54. The lid 54 has a pair of longitudinal sidewalls 58 and a pair of transverse sidewalls 62 depending from a generally rectangular top panel 56. The transverse sidewalls 62 each have an arcuate cut-out 68, and the longitudinal sidewalls each may have apertures 60. The tray 40 has a pair of longitudinal legs 46 and a pair of transverse legs 48 depending from a generally rectangular bottom panel 44. Vents are provided in one or more of the legs 46 and 48 for moisture and heat venting during and after microwave cooking. For example, the transverse legs 48 each may have an arcuate cut-out 42, as illustrated in FIG. 3, and the longitudinal legs 46 each may have apertures (not shown). Each of the longitudinal legs 46 has an upward extension 50 which extends above the bottom panel 44.

A susceptor surface 62 is disposed on an inner, food product-facing side of the top panel 56 of the lid 54 and a separate susceptor surface 52 is disposed on an inner, food product-facing side of the bottom panel 44 of the tray 40. During microwave cooking of the food product 30 between the lid 54 and tray 40, the susceptors contact the top and bottom of the food product 30 to provide for browning and heat conduction.

The upward extensions 50 of the longitudinal legs 46 assist in restricting lateral movement of the food product 30 prior to removal from the tray 40, such as during packaging and during microwave cooking. In addition, the extensions 50 can contain any portion of the food product 30 that has escaped from between the upper and lower portions 32 and 34 thereof. For example, the extensions 50 can contain a food product, such as cheese, that has melted from between the upper and lower portions 32 and 34 of the food product 30 and restrict such melted food product from contacting interior surfaces of a microwave.

The longitudinal sidewalls 58 of the lid 54 are preferably, though not necessarily, flared outwardly toward their bottom extents. That is, the transverse distance between the lower tips of the sidewalls 58 is greater than the distance between the upper tips of the sidewalls 58 adjacent the lid surface 56, such as illustrated in FIGS. 3a and 3b. Preferably, though not necessarily, the transverse distance between the lower tips of the sidewalls 58 is also greater than the distance between the upper tips of the extensions 50. In addition, it is preferable that the transverse sidewalls 62 of the lid 54 are also flared outwardly toward their bottom extents. The flaring, if present, of the sidewalls 58 and 62 of the lid 54 is such that they can at least partially fit around the upper portions of the extensions 50, thus accommodating shrinkage in the thickness of the food product 30 by that amount. In addition, the sidewalls 58 of the lid 54 can cooperate with the leg extensions 50 of the tray 40 to restrict movement of the lid 54 relative to the tray 40. The flared sidewalls 60 and 62 also can provide gripping surfaces spaced from the food product 30 at their lower tips that can be grasped to lift the lid 54 from the food product 30 after microwave cooking, such as when the susceptor 64 and food product 30 are heated. Similarly, the legs 46 and 48 and extensions 50 of the tray 40 can provide surfaces for gripping.

The tray 40 and lid 54 with the food product 30 therebetween can be contained within an outer wrapper 14, such as illustrated in FIGS. 1 and 2. If this is the case, then the outer wrapper 14 can be removed from around the combined tray 40, lid 54 and food product 30 and inserted into a microwave for cooking. The tray 40, lid 54 and food product 30, all within the wrapper 14, may be placed within an outer carton 12. The outer carton 12 may have end flaps 16 and 18 which can be opened to gain access to the cooking apparatus 20, such as illustrated in FIG. 1. The outer carton 12 may have indicia and/or graphics thereon. If no outer carton 12 is used, then one or both of the tray 40 and lid 54 may have indicia and/or graphics thereon. The corners and edges of the tray 40 and lid 54 are preferably slightly rounded to minimize their ability to puncture the outer wrapper, such as during packaging or subsequent handling.

When the tray 40, lid, 54 and food product 30 are packaged within the outer wrapper 14, they may be treated with a gas during a flushing procedure. During such gas-flushing, it is desirable for the gas to be able to enter and exit the wrapper with minimal restriction. To this end, the arcuate cut-outs 42 in the transverse legs 48 of the base and the arcuate cut-outs 68 in the transverse sidewalls 62 of the lid 54 facilitate the flow of gas around the food product 30 and into and out of the wrapper 14 during a gas-flushing process. If apertures are present on any of the sidewalls 58 and 62 of the lid, such as the apertures 60 on the longitudinal sidewalls 58 of the lid 54, and any of the legs 46 and 48, then they can assist in fluid flow during a gas-flushing process, as well as for venting of moisture and heat during and after microwave cooking.

Alternatively, the food product 30 alone can be wrapped in a wrapper. If this is the case, then the food product 30 removed from between the tray 40 and lid 54 can be removed from the wrapper. The food product 30 can then be replaced on the bottom panel 44 of the tray 40 and the lid 54 placed on top of the food product 30 to prepare the food product 30 for microwave cooking.

In use, the legs 48 and 46 elevate the food support surface 44, and thus the food product 30, above the bottom floor of a microwave oven. The food product support surface 44 cooperates with the legs 46 and 48 to form a substantially enclosed cavity beneath the food product disposed on top of the susceptor 52 of the tray 40. Preferably, the legs 46 and 48 raise the food product support surface 44 an elevation sufficient to allow for microwaves to reflect off of the sidewalls and bottom wall of a microwave and be directed to the underside of the food product support surface 44, i.e., the side opposite the susceptor 52, to provide for heating of the bottom of the food product. For example, the legs 46 and 48 may elevate the food product support surface 44 between about 0.25 and 1.75 inches above the bottom wall of a microwave for a frozen food product having a weight of between about two ounces and twelve ounces, a thickness of between about 1 inch and 4 inches, a length of between about 4 inches to seven inches and a width of between about 2 inches and 5 inches. The legs 46 and 48 can also provide for improved rigidity of the tray 40 when interconnected, such as by folding or gluing.

Although not illustrated, a series of aligned apertures may be formed in the food product support surface 44 and susceptor 52 to allow steam vapor exiting the food product during the cooking cycle to enter the cavity below the food product support surface 44 and between the legs 46 and 48. Excess amounts of steam, or water vapor beyond that desired, is allowed to exit the cavity through vents in the legs 46 and 48, such as the arcuate cut-outs 42 of the transverse legs 48 or through apertures in one or more of legs 46 and 48 (not shown). A defined amount of steam is thus trapped beneath the food product support surface 44 to provide an amount of additional heating to the food product 30 as well as maintaining moisture control of the food product environment during the cooking cycle.

In use, the lid 54 is disposed on top of the upper portion 32 of the food product 30 so as to provide additional heat energy via the susceptor 64 disposed on the underside of the lid surface 56 to the upper portion 32 of the food product 30 for browning, crisping and formation of surface crust by conductive heat which can be desirable for sandwich, pocket or other such food products having dough-based portions. The optional apertures 60 in the depending sidewalls 58 of the lid 64 allow for venting of moisture and heat and may be employed to prevent the food product from becoming soggy, as needed.

The lid 54 is free to ride along with the upper portion 32 of the food product 30, such as during the proofing stage when the dough-based portions increase in thickness or during the contraction stage when the dough-based portions decrease in thickness, depending upon the type of dough-based product. Due to the depending sidewalls 58 and 62, the lid 54 generally self centers about the food product 30, despite shape and size transformations during the cooking cycle. After cooking, the lid 54 is removed from the top portion 32 of the food product 30, leaving a desirable crisp, brown surface.

The susceptor 64 on the inner face of the lid surface 56 may be of any desirable composition and may be the same or different from the susceptor 52 on the upper surface of the food product support surface 44 of the tray 40. For example, the susceptors 52 and 64 may be different to provide for different cooking properties, such as if different heating and/or crisping is desired for the top and bottom portions 32 and 34 of the food product 30. In addition, the susceptors 52 and 64 may have different thickness and amounts of susceptor material compared to each other or within each individual susceptor 52 and 64. By graduating the amount of susceptor material or coating, control over the heating of certain portions of the food product can selectively varied during cooking. Virtually any pattern of susceptor coating on the upper surface of the food product support surface 44 and the inner face of the lid surface 56 can be employed. For example, the susceptor material can be coated as a series of space-apart diagonal stripes or can comprise an array of dots or other shapes which are grated in size and spacing from the center to the periphery of the susceptors 52 and 64.

The lid 54 is free to move relative to the tray 40. Microwave cooking of a dough-based food product can result in the food product shrinking or expanding, thereby either increasing or decreasing the thickness of the food product 30. For example, the thickness of a top bun 32 of a sandwich 30 can decrease during microwave heating due to moisture loss from the top and bottom buns 32 and 34. The free-floating lid 54 of the cooking apparatus 20 described herein is able to maintain contact with the upper surface of the top bun 32 as the top bun 32 decreases in thickness due to the lid 54 resting on the upper surface of the top bun 32 and the lid 54 being unattached to the tray 40. This advantageously permits the susceptor 62 on the inner side of the top panel 56 of the lid 54 to remain in contact with the top surface of the bun 32 to promote conductive heating and crisping.

The top surface of the upper portion 32 of the food product 30 may have surface irregularities, and thus may not be entirely planer. For example, there may be a curve to the top surface 32 of the food product, such as if the food product is a calzone. Similarly, the lower surface of the bottom portion 34 of the food product may also have surface irregularities. Thus, the susceptors 52 and 64 may not be in direct contact with the entirety of the top surface of the upper portion 32 and the lower surface of the bottom portion 34 of the food product 30, such as illustrated in FIG. 3a. To accommodate these irregularities and promote more contact with the top and bottom surfaces of the food product 30, one or both of the susceptors 52 and 64 may expand upon heating. A presently preferred type of expanding susceptor material is made and sold by Graphics Packaging, Inc. under the trade name QuiltWave™. As the susceptors 52 and 64 expand, they can at least partially contact some of the non-planar portions of the top and bottom surfaces of the food product 30, such as illustrated in FIG. 3b. In addition, or instead, a patterned susceptor surface may be utilized to focus the heating properties in particular areas, such as, for example, the center portion of a food product or the periphery of a food product.

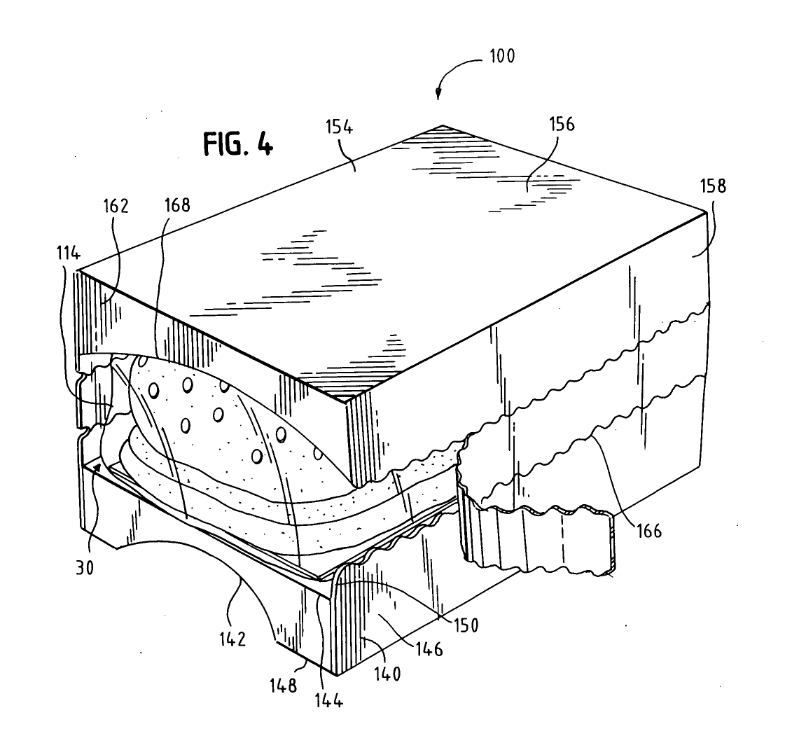

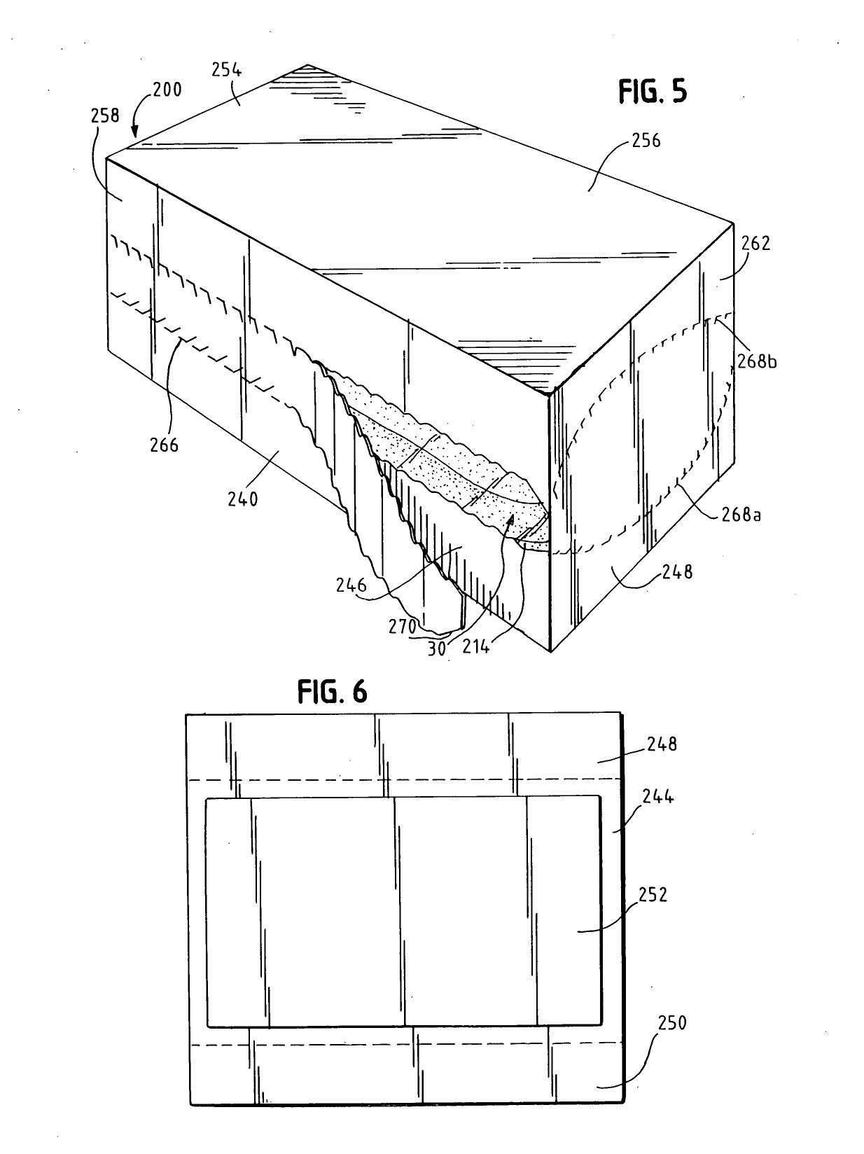

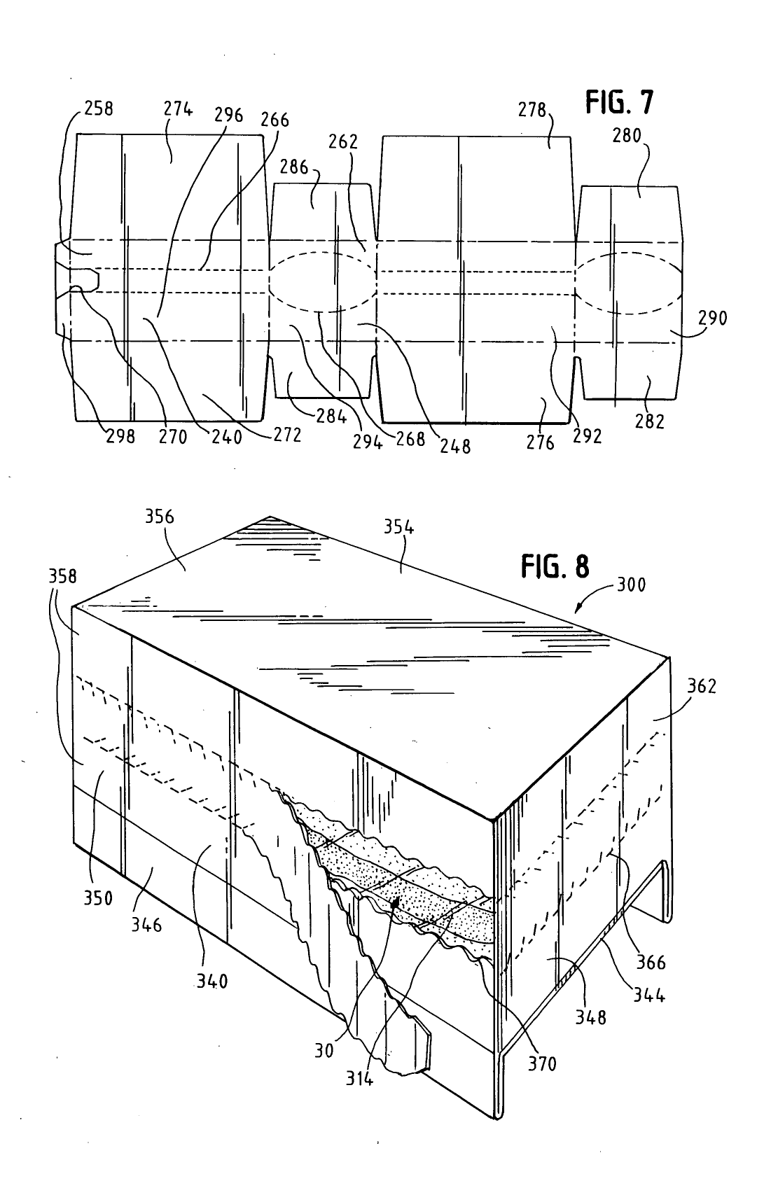

In several alternative embodiments, illustrated in their assembled configurations in FIGS. 4, 5 and 8, the tray 140, 240 and 340 and lid 154, 254 and 354 are initially joined together via at least one tear strip 166, 266 and 366. A pair of tear strips 166 may be provided only between the leg extensions 150 of the tray 140 and the longitudinal sidewall 158 of the lid 154, as illustrated in the cooking apparatus 100 of FIG. 4. Alternatively, a single tear strip 266 and 366 may extend around all four sides of the cooking apparatus 200 and 300, as illustrated in the cooking apparatus 200 and 300 of FIGS. 5 and 8, including between the leg extensions 250 and 350 of the tray 240 and 340 and the longitudinal sidewalls 258 and 358 of the lid 254 and 354 and between the front sidewall 262 and 362 of the lid 254 and 354 and a front panel 248 or leg extension 348 of the tray 240 and 340. The single tear strip 266 or pair of strips 166 may have about the same width, as illustrated in the cooking apparatus 100 and 300 of FIGS. 4 and 7, or the tear strip 266 may include a pair of enlarged, arcuate portions 268a and 268b in one or both of the front and rear panels, as illustrated in the cooking apparatus 200 of FIG. 5. The tear strips 266 and 366 may have initiators 270 and 370, such as unattached tabs, to assist in initiating removal of the strips 266 and 366 from the cooking apparatus 200 and 300.

The lids of the second, third and fourth embodiments 154, 254 and 354 are similar in construction to the lid 54 of the first embodiment, having a pair of longitudinal sidewalls 158, 258 and 358 and a pair of transverse sidewalls 162, 262 and 362 depending from a generally rectangular top panel 156, 256 and 356. The transverse sidewalls 162 of the embodiment of FIG. 4 and the transverse sidewalls 262 of the embodiment of FIG. 5, after removal of the tear strip 266, both have arcuate regions, such as for the reasons discussed above. However, the transverse sidewall 362 of the embodiment of FIG. 7 is generally rectangular.

The tray 140 of the embodiment illustrated in FIG. 4 is also similar in construction to the tray 40 of the first embodiment, having a pair of longitudinal legs 146 and a pair of transverse legs 148 depending from a generally rectangular bottom panel 144. The transverse legs 148 each have an arcuate cut-out 142, and the longitudinal legs 146 each may have apertures. Each of the longitudinal legs 146 has an upward extension 150 which extends above the bottom panel 144.

The tray 240 of the embodiment illustrated in FIG. 5 is closed, having a food product support panel 244, a pair of depending longitudinal legs 246, a pair of depending transverse legs 248, and a bottom panel (formed of a pair of panels 272 and 276). Vents may be provided in any of these panels or legs for venting moisture, heat or fluid during gas flushing. In one aspect, a gap may be provided between the arcuate cut out 268a and the food product support panel 244 to permit venting therebetween. Leg extensions 250 of the longitudinal legs 246 are also optionally provided and extend above the food product support panel 244 for the reasons discussed above.

The tray 340 of the embodiment illustrated in FIG. 7 has a generally rectangular bottom panel 344 with only a pair of depending longitudinal legs 346, thereby leaving the front and back space beneath the bottom panel 344 open. Leg extensions 350 and 352 extend upwardly from both the longitudinal and transverse edges of the bottom panel 344 for the reasons discussed above. Vents may be provided in any of these legs and panels for venting moisture, heat or fluid during gas flushing.

A susceptor surface is disposed on an inner, food product-facing side of the top panel 156, 256 and 356 of the lid 154, 254 and 354 and a separate susceptor surface 252 is disposed on an inner, food product-facing side of the bottom panel 144, 244 and 344 of the tray 140, 240 and 340. During microwave cooking of the food product 30 between the lid 154, 254, and 354 and tray 140, 240 and 340, the susceptors contact the top and bottom of the food product 30 to provide for browning and heat conduction, as discussed in greater detail above with respect to the first embodiment.

As discussed with respect to the first embodiment, the upward extensions 150, 250, 350 and 348 assist in restricting lateral movement of the food product 30 prior to removal from the tray 140, 240 and 340. In addition, the upward extensions 150, 250, 350 and 348 of the tray 140, 240 and 340 of the second, third and fourth embodiments are each initially joined to the longitudinal sidewalls 158, 258 and 358 of the lid 154, 254 and 354 via the tear strips 166 or strip 266 and 366. In order to separate the lid 154, 254 and 354 from the tray 140, 240 and 340, the tear strips 166 or strip 266 and 366 can be removed.

A pair of blanks, such as paperboard blanks, may be used to form the cooking apparatus 200. An outer blank, as illustrated in FIG. 7, may be used to form the outer surfaces of the apparatus 200, such as the top surface 256 and sidewalls 258 and 262 of the lid 254 and the legs 246, leg extensions 250, transverse legs 248 and bottom of the tray 240. The product support panel 244 is a separate blank, as illustrated in FIG. 6, that includes a pair of attachment legs 244a on each side thereof for attachment to the inner sides of the longitudinal legs 246. The outer blank includes multiple panels connected via scored lines suitable for facilitating folding into the cooking apparatus 200. The panels include four top panels 274, 286, 278 and 280 for forming the top surface 256 of the cover 254; four panels 272, 284, 276 and 282 for forming the bottom of the tray 240; a pair of longitudinal side panels 296 and 292 for forming the longitudinal legs 246, longitudinal sidewalls 258, side tear strips 266, and leg extensions 250; a pair of transverse side panels 294 and 290 for forming the arcuate portions 268a and 268b of the tear strip, the transverse sidewalls 262 and the transverse legs 248; and an end flap 298 connected to one of the longitudinal side panels 296 for joining to one of the transverse side panels 290.

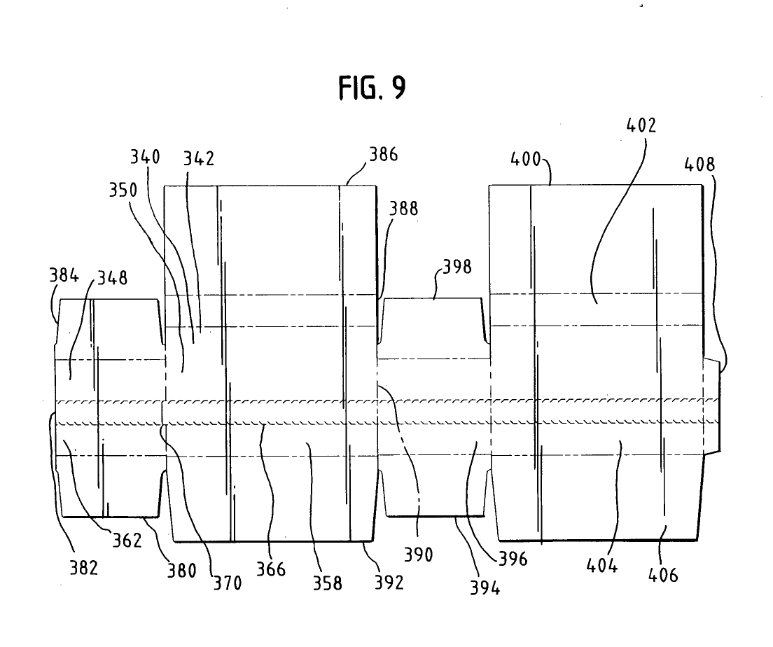

A single blank, such as paperboard blank, may be used to form the cooking apparatus 300, as illustrated in FIG. 9. The blank includes multiple panels connected via scored lines suitable for facilitating folding into the cooking apparatus 300. The panels include four top panels 380, 392, 394 and 406 for forming the top surface 356 of the cover 354; four panels 384, 386, 398 and 400 for forming the bottom, product support surface 344; a pair of longitudinal side panels 390 and 404 for forming the longitudinal legs 346, longitudinal sidewalls 358, side portions of the tear strips 366, and leg extensions 350; a pair of transverse side panels 382 and 396 for forming the front and rear portions of the tear strips 366, the transverse sidewalls 362 and the transverse legs 348; and an end flap 408 connected to one of the longitudinal side panels 404 for joining to one of the transverse side panels 382. A pair of elevating panels 388 and 402 are disposed between the longitudinal side panels 390 and 404 and the panels 386 and 400 forming a portion of the bottom 344, and serve to position the bottom 344 above the legs 342 when the blank is assembled.

Although tear strips 166, 258 and 358 are described herein, other ways of joining the tray 140, 240 and 340 and the lid 154, 254 and 354 can be equally suitable. For example, instead of the tear strips 166, 266 and 366, the upward extensions 150, 250, 350 and 348 can be joined to the adjacent longitudinal sidewall 158, 258 and 358 of the lid 154, 254 and 354 via a score line, a perforated line or a thinned die line. In addition, any of the depending sidewalls of the lid 154, 254 and 354 can be joined to the adjacent legs of the tray 140, 240 or 340 or the bottom panel, such as with a tear strip, a score line, a perforated line or a thinned die line.

The food product 30 alone can be wrapped in a wrapper 114, 214 and 314, such as illustrated in FIGS. 4, 5 and 7. If this is the case, then, following removal of each of the tear strips 166 or strip 266 and 366, the lid 154, 254 and 354 and tray 140, 240 and 340 are separated, the food product 30 removed from the tray 140, 240 and 340 and taken from the wrapper 114, 214 and 314. The food product 30 can then be replaced on the bottom panel 144, 244 and 344 of the tray 140, 240 and 340 and the lid 154, 254 and 354 placed on top of the food product 30 to prepare the food product 30 for microwave cooking.

Alternatively, the tray 140, 240 and 340 and lid 154, 254 and 354 in the joined configuration prior to removal of the tear strips 166 or strip 266 and 366 and with the food product 30 therebetween can be contained within an outer wrapper (not shown). If this is the case, then the outer wrapper can be removed from around the combined tray 140, 240 and 340 and lid 154, 254 and 354 and food product 30. Next, the tear strips 166 or strip 266 and 366 can be removed to separate the tray 140, 240 and 340 and lid 154, 254 and 354, and then the tray 140, 240 and 340, lid 154, 254, 354 and food product 30 are ready for microwave cooking. In this example, the tray 140, 240 and 340 and lid 154, 254 and 354 in the joined configuration may have indicia and graphics on outer surfaces thereof, and may have a cut-out 168 may be sized to permit viewing of the food product 30.

Preferred embodiments of a cooking apparatus are illustrated herein as having a generally rectangular form. Other forms such as polygons, circles, ovals and other irregular rounded shapes may also be used for the susceptors, tray and lid. In addition, various features from any of the different embodiments specifically discussed herein can be combined with others of the different embodiments.

The components and methods disclosed herein are particularly suitable for use with food products having upper and lower dough-based components, such as the sandwich illustrated herein, having an upper and lower bun 32 and 34 with a meat product 36 therebetween. Other examples of food products having dough-based components include calzones, pitas, pizzas, strombollis and other such dough-enrobed or dough-based food products.

The dough-based portions of the food products can be in various forms, such as raw dough which is continuously processed during a cooking cycle to expanded dough which is at least partly exposed, with the exposed portions being cooked, browned, and crisped. Raw, ready-to-heat, ready-to-eat, proofed or unproofed dough used in frozen sandwiches, pockets or the like tends to exhibit volume change during a cooking cycle, especially during the initial phase of the cooking cycle. For example, frozen sandwiches or pockets using raw, proofed or unproofed dough can exhibit an increase in thickness during a cooking cycle. Conversely, par-baked or precooked dough-based portions of a sandwich or pocket can exhibit volume contraction during a cooking cycle. The cooking apparatus disclosed herein, and particularly the free-floating lid, accommodates dough expansion and contraction during the overall cooking cycle.

The drawings and the foregoing descriptions are not intended to represent the only forms of the components and kits in regard to the details of construction and manner of operation. Changes in form and in the proportion of parts, as well as the substitution of equivalents, are contemplated as circumstances may suggest or render expedient; and although specific terms have been employed, they are intended in a generic and descriptive sense only and not for the purposes of limitation.

1. A cooking apparatus for use in microwave cooking of a food product, the cooking apparatus comprising:
a base tray for supporting the food product, the base tray having a food product support surface with a susceptor and depending legs for elevating the food product support surface; and
a cover lid having at least a pair of opposing sidewalls depending from a cover surface with a susceptor, the cover lid being unattached to the base member and the cover surface having substantially the same shape as the food product support surface.

2. A cooking apparatus in accordance with claim 1, wherein the food product has an upper portion and a lower portion that are dough-based.

3. A cooking apparatus in accordance with claim 2, wherein the legs of the base member each include one or more vents, wherein at least one of the vents is one of an aperture formed in the leg and an arcuate cut-out.

4. A cooking apparatus in accordance with claim 3, wherein:
the cover surface of the cover lid is generally polygonal, and each side has a depending sidewall; and
the food product support surface of the base tray is generally polygonal, and each side has a depending leg.

5. A cooking apparatus in accordance with claim 4, wherein the base member has a pair of upstanding extensions disposed on an opposite side of the food product support surface from the depending legs, a distance between an upper extent of the extensions being less than a distance between a lower extent of an opposing pair of the sidewalls.

6. A cooking apparatus in accordance with claim 3, wherein at least one of the susceptors can expand upon heating to at least partially conform to the adjacent surface of the food product.

7. A cooking apparatus having a first configuration for storage convertible to a second configuration for use in microwave cooking of a food product, the cooking apparatus comprising:
a base tray for supporting the food product, the base tray having a food product support surface with a susceptor on one side and legs for elevating the food product support surface;
a cover lid having at least a pair of opposing sidewalls depending from a cover surface with a susceptor on a side facing the susceptor of the food product support surface; and
means for joining the base tray and the cover lid in the first configuration of the cooking apparatus, the means for joining the base tray and the cover lid permitting separation of the base tray from the cover lid to convert the cooking apparatus from the first configuration to the second configuration.

8. A cooking apparatus in accordance with claim 7, wherein the means for joining the base tray and the cover lid comprise one of a tear strip, a thinned die line, a perforated line and a score line.

9. A cooking apparatus in accordance with claim 8, wherein the cover surface has substantially the same plan shape as the food product support surface.

10. A cooking apparatus in accordance with claim 9, wherein upper and lower portions of the food product are dough-based.

11. A cooking apparatus in accordance with claim 10, wherein the legs of the base member each include one or more vents.

12. A cooking apparatus in accordance with claim 11, wherein at least one of the vents is an aperture formed in the leg.

13. A cooking apparatus in accordance with claim 11, wherein at least one of the vents is an arcuate cut-out.

14. A cooking apparatus in accordance with claim 11, wherein:
the cover surface of the cover lid is generally polygonal, and each side has a depending sidewall; and
the food product support surface of the base tray is generally polygonal, and each side has a depending leg.

15. A cooking apparatus in accordance with claim 14, wherein the base member has a pair of upstanding extensions disposed on an opposite side of the food product support surface from the depending legs, the upstanding extensions being connected to adjacent depending legs via the means for joining in the storage configuration of the cooking apparatus.

16. A cooking apparatus in accordance with claim 11, wherein at least one of the susceptors expands upon heating to at least partially conform to the adjacent surface of a food product.

17. A cooking apparatus in accordance with claim 7, wherein the cover lid and base tray are formed from a unitary blank.

18. A cooking apparatus in combination with a food product, the cooking apparatus having a first configuration for storage and a second configuration for use in microwave cooking of the food product, comprising in combination:
a food product having a dough-based upper portion and a dough-based lower portion;
a base tray for supporting the food product, the base tray having a food product support surface with a susceptor on a side facing the lower portion of the food product and legs for elevating the food product support surface; and
a cover lid having at least a pair of opposing sidewalls depending from a cover surface with a susceptor on a side facing the upper surface of the food product, the cover lid being unattached to the base tray in the second configuration of the cooking apparatus.

19. A cooking apparatus in combination with a food product in accordance with claim 18, wherein the cooking apparatus in combination with a food product is packaged in an outer film wrapper.

20. A cooking apparatus in combination with a food product in accordance with claim 18, including means for joining the base tray and the cover lid in the first configuration of the cooking apparatus, the means for joining the base tray and the cover lid permitting separation of the base tray from the cover lid to convert the cooking apparatus from the first configuration to the second configuration.
